(19) United States
(12) Patent Application Publication
(10) Pub. No.: US 2007/0291696 A1
(43) Pub. Date: Dec. 20, 2007

(54) METHOD AND APPARATUS FOR PERFORMING RANDOM ACCESS IN A WIRELESS COMMUNICATION SYSTEM

(75) Inventors: Guodong Zhang, Farmingdale, NY (US); Kyle Jung-Lin Pan, Smithtown, NY (US); Allan Yingming Tsai, Boontown, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/763,862

(22) Filed: Jun. 15, 2007

Related U.S. Application Data
(60) Provisional application No. 60/815,246, filed on Jun. 19, 2006.

(51) Int. Cl. H04Q 7/00

(52) U.S. Cl. 370/331

(57) ABSTRACT

A method and apparatus for random access in an evolved universal terrestrial radio access (E-UTRA) system are disclosed. For code division multiplexing (CDM), a basic preamble is generated using a constant amplitude zero auto-correlation (CAZAC) sequence. The basic preamble is repeated for M time for generating a random access channel (RACH) preamble. For time division multiplexing/frequency division multiplexing (TDM/FDM), an extended CAZAC sequence is used to generate the basic preamble. Alternatively, a hybrid RACH access period including at least one CDM random access slot and at least one TDM/FDM random access slot may be provided. For synchronized random access, a RACH burst including a preamble part, a message part, and two cyclic prefixes may be generated and transmitted

### CROSS REFERENCE TO RELATED APPLICATION

This application claims the benefit of U.S. Provisional Application No. 60/815,246 filed Jun. 19, 2006, which is incorporated by reference as if fully set forth.

### FIELD OF INVENTION

The present invention is related to wireless communication systems. More particularly, the present invention is related to a method and apparatus for random access in an evolved universal terrestrial radio access (E-UTRA) system.

### BACKGROUND

In order to keep wireless communication technology competitive, both third generation partnership (3GPP) and 3GPP2 are considering long term evolution (LTE) for enhanced radio interface and network architecture. Single carrier frequency division multiple access (SC-FDMA) is adopted as an air interface for the uplink of E-UTRA. Details of SC-FDMA can be found in the 3GPP Technical Specification entitled “Physical Layer Aspects for Evolved UTRA” (Release 7), 3GPP TR25.814 V0.1.1 (2005-06). Since uplink transmissions using SC-FDMA or orthogonal frequency division multiple access (OFDMA) rely on the inherent orthogonality to avoid multiple access interference (MAI) among users, it is imperative that users and a base station are synchronized in time, (i.e., uplink synchronization). If proper uplink synchronization is not achieved, an MAI will occur due to the loss of orthogonality, which in turn will degrade the system performance dramatically.

Before a user starts to transmit data in the uplink of the network, uplink timing has to be acquired first by the user in a contention-based manner. The contention-based channel is usually called a random access channel (RACH). The base station also identifies the user through the RACH. A RACH burst contains a preamble, which is used to allow the base station to properly identify the users and estimate uplink timing. A properly designed RACH preamble is essential for the uplink operation.

The random access procedure is classified into two categories: non-synchronized random access and synchronized random access. The non-synchronized random access is used when a wireless transmit/receive unit (WTRU) has not been time synchronized for uplink, or the uplink synchronization has been lost. The non-synchronized access allows the Node-B to estimate and, if needed, adjust the WTRU transmission timing to within a fraction of a cyclic prefix (CP). The synchronized random access is used when the WTRU is time synchronized for uplink with the Node-B.

Non-synchronized random access transmissions are restricted to certain time and frequency resources when using time division multiplexing (TDM) and frequency division multiplexing (FDM), respectively. The non-synchronized random access transmissions may not be restricted to certain time or frequency resources when using code division multiplexing (CDM).

In one 3GPP LTE proposal, (3GPP Tdoc R1-061168, Preamble Sequence Design for Random Access of E-UTRA, Motorola), Hadamard extended general chirp-like (GCL) sequences are used to build a random access preamble sequence. FIG. 1 shows generation of the conventional RACH preamble and transmission of the RACH preamble with a CP. However, this preamble structure does not allow simple receiver processing. To detect the preamble, the receiver has to perform extensive correlation within a sliding window. In addition, when there are multiple random access attempts at (or around) the same time using different preambles, the performance degrades dramatically due to the poor aperiodic cross-correlation properties.

### SUMMARY

The present invention is related to a method and apparatus for random access in an E-UTRA system. The present invention is applicable to a wireless communication system utilizing SC-FDMA or OFDMA. For CDM, a basic preamble is generated using a constant amplitude zero auto-correlation (CAZAC) sequence. The basic preamble is repeated for M time for generating a RACH preamble. For TDM/FDM, an extended CAZAC sequence is used to generate the basic preamble. Alternatively, a hybrid RACH access period including at least one CDM random access slot and at least one TDM/FDM random access slot may be provided. For synchronized random access, a RACH burst including a preamble part, a message part, and two cyclic prefixes may be generated and transmitted

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows generation of the conventional RACH preamble and transmission of the RACH preamble with a CP;

FIG. 2 shows a RACH preamble for CDM in accordance with a first embodiment of the present invention;

FIG. 3 shows a transmitter for generating and transmitting a RACH preamble in accordance with the first embodiment of the present invention;

FIG. 4 shows a RACH access slot for CDM based RACH;

FIG. 5 shows a Node-B in accordance with the present invention;

FIG. 6 shows the search window for correlation at the Node-B;

FIG. 7 shows a RACH preamble transmission within a RACH access slot in accordance with a second embodiment;

FIG. 8 shows an example of an extended CAZAC sequence;

FIG. 9 shows a transmitter for generating and transmitting a RACH preamble in accordance with the second embodiment of the present invention;

FIG. 10 shows an exemplary hybrid random access period in accordance with a third embodiment of the present invention;

FIG. 11 shows a RACH burst for synchronized random access in accordance with a fourth embodiment of the present invention.

### DETAILED DESCRIPTION OF THE PREFERRED EMBODIMENTS

When referred to hereafter, the terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “Node-B” includes but is not limited to a base station, a site controller, an access point (AP), or any other type of interfacing device capable of operating in a wireless environment.

FIG. 2 shows a RACH preamble 200 for CDM in accordance with a first embodiment of the present invention. The RACH preamble 200 with duration Tₚ comprises M repetitions of a basic preamble 202 with duration T_{bp}, (i.e., symbol 1 . . . symbol M). The time duration T_{bp} corresponds to the length of N samples. Due to the CDM nature, no guard time, (or CP), is used in the RACH preamble 200. A CAZAC sequence is used to build the basic preamble 202. Different RACH preambles may be generated by using cyclically shifted CAZAC sequences in the basic preamble. One example of the CAZAC sequence is a generalized chirp like (GCL) sequence. Hereinafter, the present invention will be explained with reference to the GCL sequence hereinafter. However, it should be noted that any other CAZAC sequences may also be used.

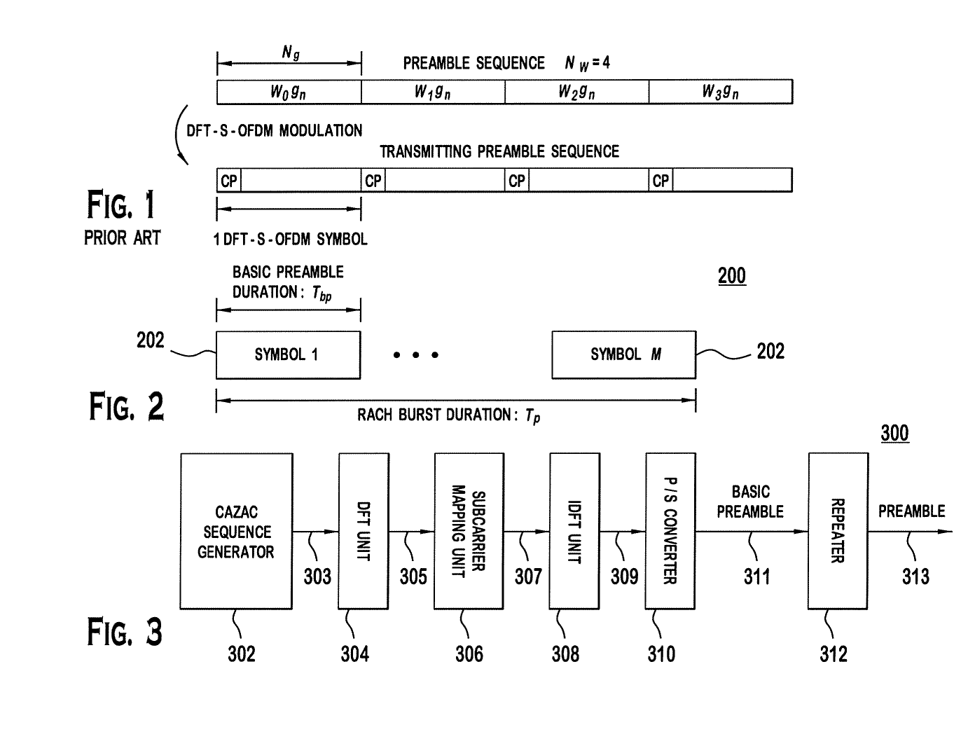

FIG. 3 shows a transmitter 300 for generating and transmitting a RACH preamble in accordance with the first embodiment of the present invention. The transmitter 300 includes a CAZAC sequence generator 302, an N_{bp}-point discrete Fourier transform (DFT) unit 304, a subcarrier mapping unit 306, an N-point inverse discrete Fourier transform (IDFT) unit 308, a parallel-to-serial (P/S) converter 310 and a repeater 312. The CAZAC sequence generator 302 generates a CAZAC sequence 303, (such as a cyclically shifted GCL sequence). The CAZAC sequence 303 consists of N_{bp} elements.

The CAZAC sequence 303 is processed by the N_{bp}-point DFT unit 304 to generate frequency domain sequence 305. The frequency domain sequence 305 is then mapped to subcarriers by the subcarrier mapping unit 306. The subcarrier mapped frequency domain sequence 307 is then processed by the N-point IDFT unit 308. In accordance with the current LTE proposal, (3GPP TR25.814), for regular uplink data channel of bandwidth 20 MHz, a 2.048 point IDFT, (i.e., equivalently 2,048 point inverse fast Fourier transform (IFFT)), is used at the transmitter 300 and one orthogonal frequency division multiplexing (OFDM) symbol duration, Tₛ, is 66.67 μs. The size of the IDFT, N, is given by Equation (1):

$$N = 2048 \times \frac{{T}_{bp}}{{T}_{s}} . \qquad Equation ( 1 )$$

Given the RACH bandwidth of 1.25 MHz and the sampling frequency of 30.72 MHz (corresponding to 20 MHz cell), the basic preamble length N_{bp} is limited by:

$${N}_{bp} \leq \frac{1.25 MHz}{30.72 MHz} \times N . \qquad Equation ( 2 )$$

For example, for a preamble duration of 400 μs, if the number of repetitions M=1, the duration of the basic preamble, T_{bp}, is also 400 μs, and the size of the IDFT is 12,288. If the number of repetitions M=2, the duration of the basic preamble, T_{bp}, is 200 μs, and the size of the IDFT is 6,144. If the number of repetitions M=3, the duration of the basic preamble, T_{bp}, is 133.33 μs, and the size of the IDFT is 4,096. It should be noted that numerical examples, (e.g., the DFT points, IDFT points, bandwidth, symbol duration, and the like), provided in the present invention are only for the purpose of illustration, not as a limitation, and any other numbers may be used.

The output 309 of the N-point IDFT unit 308 is then converted to serial data by the P/S converter 310. The output of the P/S converter 312 is a basic preamble 311. The basic preamble 311 is repeated M times by the repeater 312 to generate a RACH preamble 313.

For example, the length of the basic preamble, T_{bp}, may be 400 μs and the RACH burst may contain two (2) repetitions of the basic preamble, (i.e., M=2). Four (4) cyclically shifted GCL sequences may be used to create four (4) different basic preambles. The length of the RACH burst may be 0.8 ms, (i.e., 2×400 μs=0.8 ms). The random access slot may be 1 ms. In such case, according to Equations (1) and (2), the IDFT size is 12,288, and the basic preamble length N_{bp} is limited by 500.

The time window for transmission of a RACH preamble, (and a RACH message, if any), is called a RACH access slot. The length of the RACH access slot for CDM-based random access is at least one RACH burst, and may be rounded up to the smallest multiples of sub-frames. Optionally, in order to enhance the performance, the length of the RACH access slot for CDM-based random access may be no less than one RACH burst plus maximum uplink timing difference between two WTRUs. This allows simpler receiver processing of receive preambles.

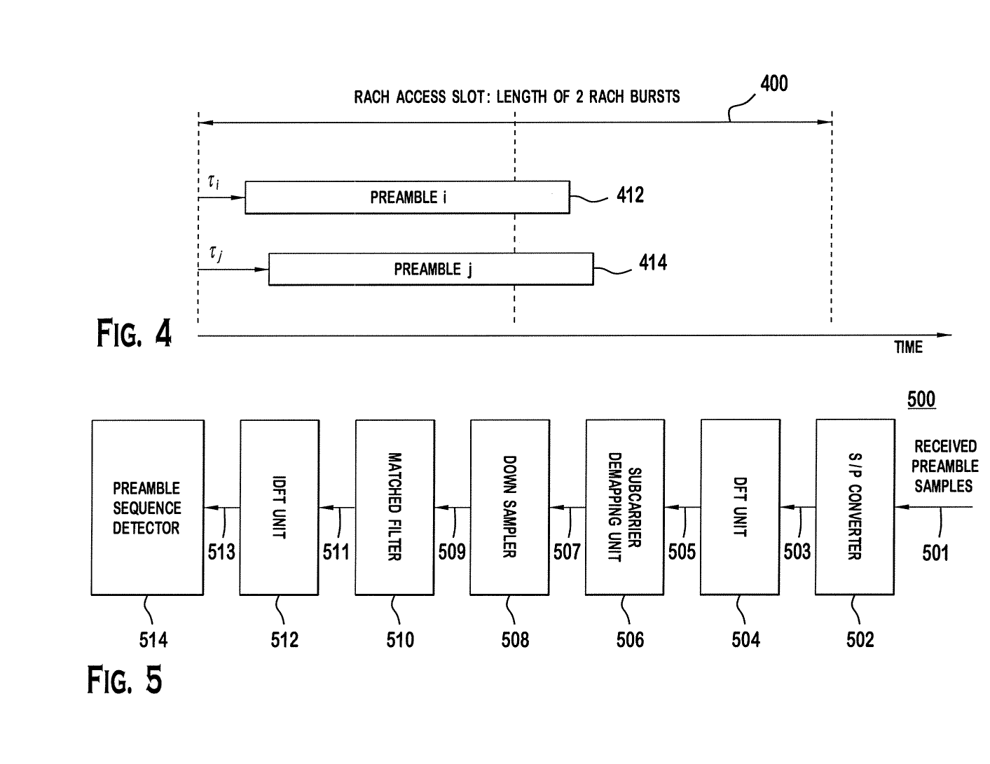

FIG. 4 shows an example of a RACH access slot 400 and transmission of RACH preambles 412, 414 from two WTRUs. In this example, the RACH access slot 400 is defined for the length of two (2) RACH bursts. The RACH preamble 412 from WTRU i and the RACH preamble 414 from WTRU j are received by the Node-B at different timing τᵢ and τⱼ.

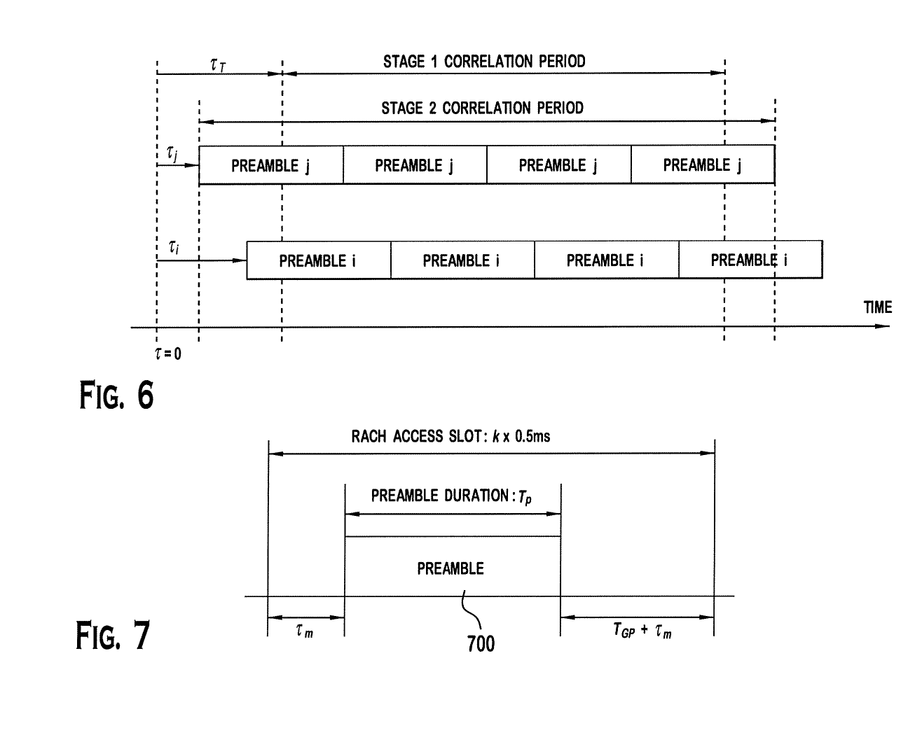

FIG. 5 shows a Node-B 500 in accordance with the present invention. The Node-B 500 includes a serial-to-parallel (S/P) converter 502, a DFT unit 504, a subcarrier demapping unit 506, a down-sampler 508, a matched filter 510, an IDFT unit 512, and a preamble sequence detector 514. At the Node-B 500, a plurality of RACH preamble samples 501 are generated using a fixed search window. The search window is shown in FIG. 6, which will be explained in detail hereinafter.

The S/P converter 502 converts the RACH preamble samples 501 in series to a parallel format. The RACH preamble samples 503 in a parallel format are converted to frequency domain data 505 by the DFT unit 504, which outputs (M−1)×N for stage 1 correlation, (or M×N for stage 2 correlation, which will be explained in detail hereinafter), samples. The frequency domain data 505 is then processed by the subcarrier demapping unit 506. After subcarrier de-mapping, the frequency domain samples 507 are down-sampled by a factor of M−1 for stage 1 correlation, (or by a factor of M for stage 2 correlation), by the down-sampler 508. The output 509 from the down-sampler 508 is denoted as Y(k), k=0, . . . , N−1 where N is the RACH basic preamble sequence length. Y(k) is processed by the matched filter 510 which outputs a correlation of the RACH preamble samples with a conjugate of the corresponding RACH preamble. The output 511 of the matched filter 510, Zᵤ(k), is given by Equation (3):

$${Z}_{u} ( k ) = \frac{1}{\sqrt{N}} Y ( k ) {G}_{u}^{*} ( k ) , k = 0 , … , N - 1 , \qquad Equation ( 3 )$$

where Gᵤ(k) is a particular RACH preamble sequence u among all possible preamble sequences used by the WTRU.

The output 511 of the matched filter 510, Zᵤ(k), is then processed by the N-point IDFT unit 512 to get a time-domain user delay profile 513, which is represented as follows:

$${Z}_{u} {\to }_{IDFT} {z}_{u} . \qquad Equation ( 4 )$$

To detect the preamble of a specific user u, the time-domain detection decision metric of user u, denoted by Λᵤ(τ), is a ratio of the output of the IDFT unit 512 to a noise variance, which is given by:

$${Λ}_{u} ( τ ) = \frac{{\vert {z}_{u} ( τ ) \vert}^{2}}{{σ}_{w}^{2}} , \qquad Equation ( 5 )$$

where σ_{w}² is an estimate of noise variance. The preamble sequence detector 514 detects the RACH preamble sequence as the preamble sequence that yields the largest correlation compared to the noise variance.

FIG. 6 shows the search window for correlation at the Node-B 500. There are two ways to perform the correlation. In a first method, both stage 1 and stage 2 correlations are performed. In a second method, only stage 2 correlation is performed. Stage 1 correlation uses a shorter search window to detect a rough peak. For the search window for stage 1 correlation, a maximum delay τ_{T} is defined to be equal to the maximum round trip delay with the cell τ_{R} plus two (2) times the maximum multipath channel delay τₛ, (i.e., τ_{T}=τ_{R}+2×τₛ). The multipath channel delay is the time delay associated with the path with the largest delay in the multipath channel. The length of the search window in stage 1 correlation is preferably (M−1)×N. Stage 2 correlation uses a longer search window to get a more precise detection with a length of M×N. The search window for stage 2 is defined as M×N sample time plus τ_{T}. Stage 2 correlation is the same as stage 1 correlation except that the search window is longer and a down-sample factor of M is used instead of M−1 as in stage 1 correlation.

Since the RACH preamble using CDM usually collides with other uplink data and/or control channels, interference cancellation or mitigation may optionally be performed. Interference cancellation or mitigation is necessary only when the interference arising from RACH preamble transmission to a shared data channel of other users is above a certain level. At each random access slot, the Node-B decodes the regular uplink data channel signals first, and removes the received power of uplink data channel signals before processing the received RACH preamble signals. Alternatively, after finding specific user timing, (i.e., correlation peak), the detected timing (peak) is reused to further perform intra-cell interference cancellation since CDM-based RACH has intra-cell interference.

When active RACH preambles are received with unequal signal strengths, a successive interference cancellation may be performed to first cancel out the strongest RACH preamble signal, and then the next strongest RACH preamble signal one by one until the interference arising from the RACH preamble transmissions to other shared channels are reduced to a predetermined level. Other interference cancellation or mitigation schemes may also be used.

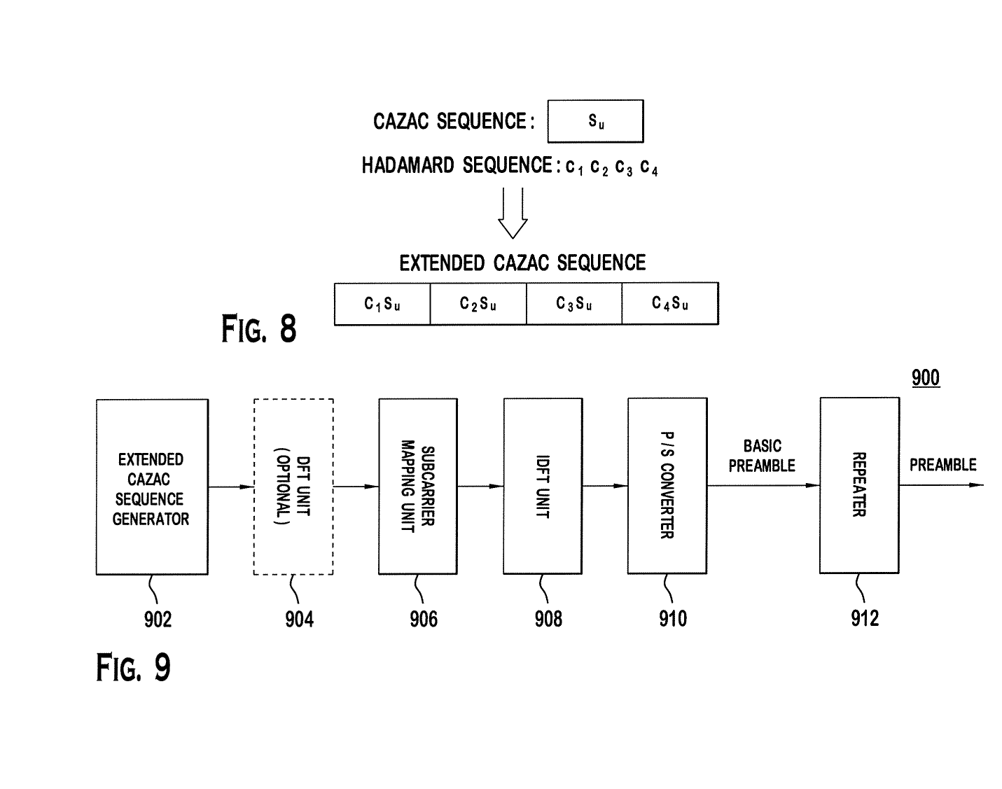

In accordance with a second embodiment of the present invention, a non-synchronized RACH preamble is transmitted using TDM/FDM. FIG. 7 shows a RACH preamble transmission within a RACH access slot in accordance with the second embodiment. The RACH preamble 700 is transmitted within the RACH access slot with guard times. The duration of the RACH access slot is equal to a single sub-frame, (e.g., 0.5 ms or 1 ms), or multiple sub-frames. A guard time, T_{GP}, which covers maximum propagation round-trip delay for a given cell size is added to the end of the RACH preamble 700. A small time, τₘ, is also added to the beginning and end of the RACH preamble 700. The duration of τₘ is equal to the cyclic prefix used in the uplink shared data channel. The value of τₘ is the same as in the first embodiment, which covers the maximum multipath channel delay. The RACH preamble 700 with duration Tₚ comprises M (M=1, 2, 3, . . . ) repetitions of a basic preamble with duration T_{bp}. The RACH access slot may be a single sub-frame slot or multiple sub-frame slot.

In accordance with the second embodiment, an extended CAZAC sequence is used to generate the basic preamble. The extended CAZAC sequence is constructed using a CAZAC sequence sᵤ (length G) and an orthogonal sequence cᵥ (length L). The CAZAC sequence may be a GCL sequence, and the orthogonal sequence may be a Hadamard sequence or an M sequence. The length of the extended CAZAC sequence equals to G×L. The extended sequence e is expressed as follows:

$$e ( n ) = {s}_{u} ( n mod G ) * {c}_{v} ( ⌊ \frac{n}{G} ⌋ ) ; \qquad Equation ( 6 )$$

where └x┘ denotes the largest integer not greater than x.

FIG. 8 shows generation of an extended CAZAC sequence. In this example, four Hadamard sequences of length four (4) are applied to the CAZAC sequence to generate the extended CAZAC sequence. Different basic preambles are created by using different orthogonal sequences or a different cyclic-shifted CAZAC sequence.

FIG. 9 shows a transmitter 900 for generating and transmitting a RACH preamble in accordance with the second embodiment of the present invention. The transmitter 900 includes an extended CAZAC sequence generator 902, an N_{bp}-point DFT unit 904 (optional), a subcarrier mapping unit 906, an N-point IDFT unit 908, a parallel-to-serial (P/S) converter 910 and a repeater 912. The transmitter 900 is the same as the transmitter 300 except that the extended CAZAC sequence generator 902, instead of a CAZAC sequence generator of FIG. 3, is used and the N_{bp}-point DFT unit 904 is optional. Therefore, the details of the transmitter 900 and the corresponding Node-B will not be explained further for simplicity.

In accordance with a third embodiment of the present invention, the non-synchronized random access preamble structure combines the first embodiment, (i.e., CDM), and the second embodiment, (i.e., TDM/FDM). One random access slot comprises k sub-frames. N_{R}(N_{R}≧2) random access slots are defined as one hybrid random access period. Out of the N_{R} random access slots, random access preambles using CDM may be transmitted in N_{C} random access slots, and random access preambles using TDM/FDM may be transmitted in the remaining N_{T/F} random access slots, (i.e., N_{T/F}+N_{C}=N_{R}).

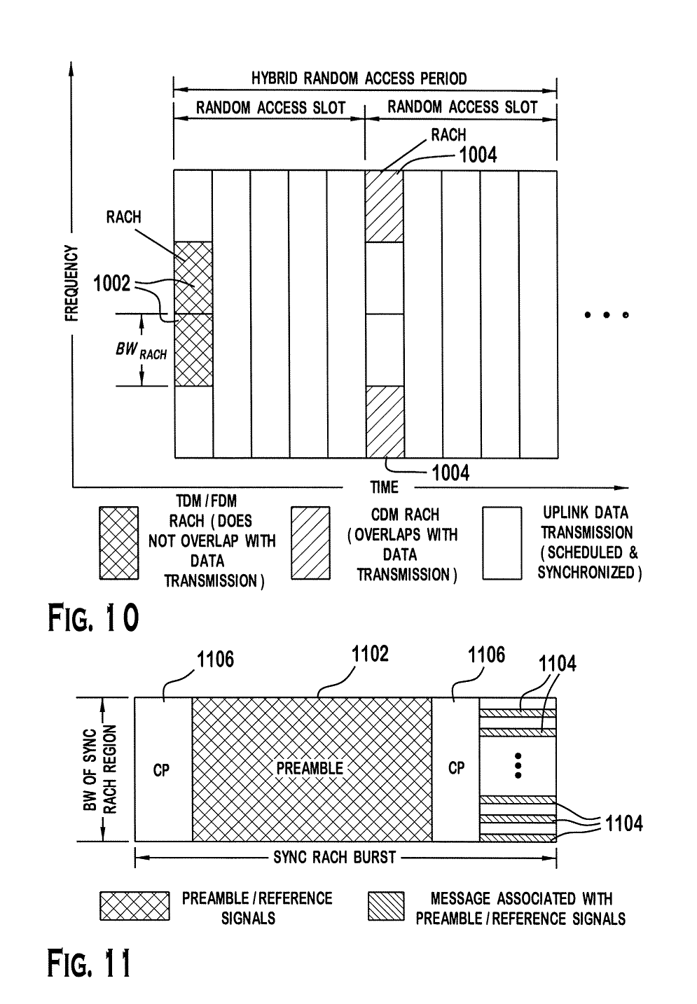

FIG. 10 shows an exemplary hybrid random access period in accordance with the third embodiment of the present invention. In this example, the hybrid random access period comprises two random access slots, (i.e., N_{R}=2). Each random access slot includes five (5) sub-frames, (i.e., k=5). Among the two random access slots of the hybrid random access period, at least one random access slot 1002 is assigned for TDM/FDM, (i.e., N_{T/F}=1), and at least one random access slot 1004 is assigned for CDM, (i.e., N_{C}=1). In this way, more flexibility that combines the advantages of both first and second embodiments is possible. It allows the system to balance the trade-off between random access detection performance and system overhead (random access latency as well).

In accordance with a fourth embodiment of the present invention, a synchronized random access is performed. FIG. 11 shows a RACH burst 1100 for synchronized random access in accordance with the fourth embodiment. The RACH burst 1100 comprises a preamble part 1102 and a message part 1104. A CP 1106 is added to both the preamble part 1102 and the message part 1104. The message part 1104 has a length of one long block, (i.e., 66.67 μs), and occupies subcarriers in a distributed mode or a localized mode. The preamble part 1102 is the same as the RACH preamble in accordance with the first and second embodiments.

For example, for a 5 MHz deployment scenario, a synchronized RACH burst 1100 is generated with a 1.25 MHz synchronized random access region. The length of the synchronized random access region may be adjusted, (e.g., on a cell basis depending on the cell size), to optimize the trade-off between overhead/latency and coverage.

The preamble part 1102 may carry implicit messages. If the preamble part 1102 carries implicit messages, the number of bits to be carried by the message part 1104 is reduced. This, in turn, reduces the number of subcarriers required for the message part 1104 and increases the number of (orthogonal) synchronized random access opportunities. For example, where 75 subcarriers are assigned for the RACH, if no implicit message is carried by the preamble part 1102 and the message part occupies 25 subcarriers for 25 bits of information, only three (3) (=75/25) message parts 1104 are supported for the random access. If 7 bits of information is carried implicitly by the preamble part 1102, the message part 1104 will occupy 18 subcarriers. Then, four (4) (≈75/18) explicit message parts 1104 may be supported for the random access.

If more control bits need to be transmitted on the synchronized random access channel, the message part 1104 may occupy more than one long block. In this way, the length of the preamble is reduced (or adjusted) accordingly.

Preambles occupying a bandwidth wider than the random access region can be used to obtain channel quality indicators (CQIs) of more resource blocks at the Node-B. Upon receiving a preamble(s) in a wider bandwidth, the Node-B may use the detected preamble sequence as reference signals to perform channel estimation in the wider bandwidth and estimate uplink channel quality of the WTRU. Based on the knowledge of channel quality of the WTRU in more resource blocks (because of wider bandwidth), a more efficient frequency domain scheduling can be performed. In this way, the Node-B may make better frequency domain scheduling for WTRUs that use synchronized random access channel to request uplink resources.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for random access in a wireless communication system including a wireless transmit/receive unit (WTRU) and a Node-B, the method comprising:
the WTRU generating a constant amplitude zero auto-correlation (CAZAC) sequence;
the WTRU performing a discrete Fourier transform (DFT) on the CAZAC sequence to generate a frequency domain sequence;
the WTRU mapping the frequency domain sequence to subcarriers;
the WTRU performing inverse discrete Fourier transform (IDFT) on the subcarrier mapped frequency domain sequence to generate a basic preamble;
the WTRU repeating the basic preamble for M times to generate a random access channel (RACH) preamble; and
the WTRU transmitting the RACH preamble to the Node-B.

2. The method of claim 1 wherein the CAZAC sequence is a generalized chirp like (GCL) sequence.

3. The method of claim 1 wherein a RACH access slot for transmitting the RACH preamble is for duration of at least one RACH preamble.

4. The method of claim 1 wherein a RACH access slot for transmitting the RACH preamble is no less than one RACH preamble plus maximum uplink timing difference between two WTRUs.

5. The method of claim 1 further comprising:
the Node-B generating RACH preamble samples using a search window;
the Node-B performing DFT on the RACH preamble samples to generate frequency domain data;
the Node-B performing subcarrier demapping on the frequency domain data;
the Node-B down-sampling the subcarrier demapped frequency domain data to generate down-sampled data;
the Node-B performing correlation of the down-sampled data with a conjugate of a corresponding RACH preamble to generate frequency domain correlation values;
the Node-B performing IDFT on the frequency domain correlation values to generate time-domain correlation values; and
the Node-B detecting the RACH preamble based on a ratio of the time-domain correlation values to a noise variance.

6. The method of claim 5 wherein both stage 1 correlation and stage 2 correlation are performed, the stage 1 correlation being performed to detect a rough peak with a shorter search window and the stage 2 correlation being performed to detect a more precise peak with a longer search window based on the rough peak.

7. The method of claim 5 wherein only stage 2 correlation with a longer search window is performed.

8. The method of claim 5 further comprising:
the Node-B performing interference cancellation.

9. The method of claim 8 wherein at each random access slot, the Node-B decodes regular uplink data channel signals first, and removes the received uplink data channel signals before processing the RACH preamble samples.

10. The method of claim 8 wherein the Node-B, after finding specific user timing, uses the detected timing to further perform intra-cell interference cancellation.

11. The method of claim 8 wherein the Node-B performs successive interference cancellation.

12. A method for random access in a wireless communication system including a wireless transmit/receive unit (WTRU) and a Node-B, the method comprising:
the WTRU generating an extended constant amplitude zero auto-correlation (CAZAC) sequence with a CAZAC sequence and an orthogonal sequence;
the WTRU mapping the extended CAZAC sequence to subcarriers;
the WTRU performing inverse discrete Fourier transform (IDFT) on the subcarrier mapped extended CAZAC sequence to generate a basic preamble;
the WTRU repeating the basic preamble for M times to generate a random access channel (RACH) preamble; and
the WTRU transmitting the RACH preamble to the Node-B within a RACH access slot with a guard time, the RACH access slot being defined with respect to at least one of frequency band and time duration of at least one sub-frame.

13. The method of claim 12 further comprising:
the WTRU performing a discrete Fourier transform (DFT) on the extended CAZAC sequence before performing subcarrier mapping.

14. The method of claim 12 wherein the guard time covers a maximum propagation round-trip delay and a small time that is equal to a cyclic prefix (CP) used in an uplink shared channel.

15. The method of claim 12 further comprising:
the Node-B generating RACH preamble samples using a search window;
the Node-B performing DFT on the RACH preamble samples to generate frequency domain data;
the Node-B performing subcarrier demapping on the frequency domain data;
the Node-B down-sampling the subcarrier demapped frequency domain data to generate down-sampled data;
the Node-B performing correlation of the down-sampled data with a conjugate of a corresponding RACH preamble to generate frequency domain correlation values;
the Node-B performing IDFT on the frequency domain correlation values to generate time-domain correlation values; and
the Node-B detecting the RACH preamble based on a ratio of the time-domain correlation values to a noise variance.

16. A method for random access in a wireless communication system including a wireless transmit/receive unit (WTRU) and a Node-B, the method comprising:
defining a hybrid RACH access period, the hybrid RACH access period including at least one code division multiplexing (CDM) random access slot and at least one time division multiplexing (TDM)/frequency division multiplexing (FDM) random access slot;
the WTRU generating a RACH preamble; and
the WTRU transmitting the RACH preamble via either the CDM random access slot or the TDM/FDM random access slot.

17. A method for random access in a wireless communication system including a wireless transmit/receive unit (WTRU) and a Node-B, the method comprising:
the WTRU generating a random access channel (RACH) burst, the RACH burst comprising a preamble part, a message part, a first cyclic prefix (CP) attached to the preamble part and a second CP attached to the message part, the preamble part comprising M repetition of a basic preamble and a guard time and carrying an implicit message; and
the WTRU sending the RACH burst in synchronization with the Node-B.

18. The method of claim 17 wherein the message part occupies subcarriers in one of a distributed mode and a localized mode.

19. The method of claim 17 wherein the preamble part occupies a bandwidth wider than a defined random access region such that the Node-B obtains a channel quality indicator (CQI) of more resource blocks.

20. A wireless transmit/receive unit (WTRU) for random access in a wireless communication system, the WTRU comprising:
a constant amplitude zero auto-correlation (CAZAC) sequence generator for generating a CAZAC sequence;
a discrete Fourier transform (DFT) unit for performing DFT on the CAZAC sequence to generate a frequency domain sequence;
a subcarrier mapping unit for mapping the frequency domain sequence to subcarriers;
an inverse discrete Fourier transform (IDFT) unit for performing IDFT on the subcarrier mapped frequency domain sequence to generate a basic preamble;
a repeater for repeating the basic preamble for M times to generate a random access channel (RACH) preamble; and
a transmitter for transmitting the RACH preamble to a Node-B.

21. The WTRU of claim 20 wherein the CAZAC sequence is a generalized chirp like (GCL) sequence.

22. The WTRU of claim 20 wherein a RACH access slot for transmitting the RACH preamble is for duration of at least one RACH preamble.

23. The WTRU of claim 20 wherein a RACH access slot for transmitting the RACH preamble is no less than one RACH preamble plus maximum uplink timing difference between two WTRUs.

24. A Node-B for processing random access channel (RACH) from a wireless transmit/receive unit (WTRU), the Node-B comprising:
a receiver for generating RACH preamble samples using a search window, the RACH preamble being generated by repeating a basic preamble for M times, the basic preamble being generated from a constant amplitude zero auto-correlation (CAZAC) sequence;
a discrete Fourier transform (DFT) unit for performing DFT on the RACH preamble samples to generate frequency domain data;
a subcarrier demapping unit for performing subcarrier demapping on the frequency domain data;
a down-sampler for down-sampling the subcarrier demapped frequency domain data to generate down-sampled data;
a correlator for performing correlation of the down-sampled data with a conjugate of a corresponding RACH preamble to generate frequency domain correlation values;
an inverse discrete Fourier transform (DFT) unit for performing IDFT on the frequency domain correlation values to generate time domain correlation values; and
a RACH preamble detector for detecting the RACH preamble based on a ratio of the time domain correlation values to a noise variance.

25. The Node-B of claim 24 wherein both stage 1 correlation and stage 2 correlation are performed, the stage 1 correlation being performed to detect a rough peak with a shorter search window and the stage 2 correlation being performed to detect a more precise peak with a longer search window based on the rough peak.

26. The Node-B of claim 24 wherein only stage 2 correlation with a longer search window is performed.

27. The Node-B of claim 24 further comprising:
an interference cancellation unit for performing interference cancellation.

28. The Node-B of claim 27 wherein at each random access slot, the interference cancellation unit removes received uplink data channel signals before processing the RACH preamble samples.

29. The Node-B of claim 27 wherein the interference cancellation unit, after finding specific user timing, uses the detected timing to further perform intra-cell interference cancellation.

30. The Node-B of claim 27 wherein the interference cancellation unit performs successive interference cancellation.

31. A wireless transmit/receive unit (WTRU) for random access in a wireless communication system, the WTRU comprising:
an extended constant amplitude zero auto-correlation (CAZAC) sequence generator for generating an extended CAZAC sequence with a CAZAC sequence and an orthogonal sequence;
a subcarrier mapping unit for mapping the extended CAZAC sequence to subcarriers;
an inverse discrete Fourier transform (IDFT) unit for performing IDFT on the subcarrier mapped extended CAZAC sequence to generate a basic preamble;
a repeater for repeating the basic preamble for M times to generate a random access channel (RACH) preamble; and
a transmitter for transmitting the RACH preamble to a Node-B within a RACH access slot with a guard time, the RACH access slot being defined with respect to at least one of frequency band and time duration of at least one sub-frame.

32. The WTRU of claim 31 further comprising:
a discrete Fourier transform (DFT) unit for performing DFT on the extended CAZAC sequence before performing subcarrier mapping.

33. The WTRU of claim 31 wherein the guard time covers maximum propagation round-trip delay and a small time that is equal to a cyclic prefix (CP) used in an uplink shared channel.

34. A wireless transmit/receive unit (WTRU) for random access in a wireless communication system, the WTRU comprising:
a random access channel (RACH) preamble generator for generating a RACH preamble; and
a transmitter for transmitting the RACH preamble during a hyper RACH access period, the hyper RACH access period including at least one of a code division multiplexing (CDM) random access slot and at least one time division multiplexing (TDM)/frequency division multiplexing (FDM) random access slot.

35. A wireless transmit/receive unit (WTRU) for random access in a wireless communication system, the WTRU comprising:
a random access channel (RACH) burst generator for generating a RACH burst, the RACH burst comprising a preamble part, a message part, a first cyclic prefix (CP) attached to the preamble part and a second CP attached to the message part, the preamble part comprising M repetition of a basic preamble and a guard time and carrying an implicit message; and
a transmitter for sending the RACH burst in synchronization with a Node-B.

36. The WTRU of claim 35 wherein the message part occupies subcarriers in one of a distributed mode and a localized mode.

37. The WTRU of claim 35 wherein the preamble part occupies a bandwidth wider than a defined random access region such that the Node-B obtains a channel quality indicator (CQI) of more resource blocks.
